(19) United States
(12) Patent Application Publication
(10) Pub. No.: US 2017/0126801 A1
(43) Pub. Date: May 4, 2017

(54) METHOD, APPARATUS, AND STORAGE MEDIUM FOR PERFORMING MEDIA SYNCHRONIZATION

(71) Applicant: Xiaomi Inc., Beijing (CN)

(72) Inventors: Kangxi TAN, Beijing (CN); Yongzhi WANG, Beijing (CN); Zhonghui HUANG, Beijing (CN)

(21) Appl. No.: 15/183,373

(22) Filed: Jun. 15, 2016

(30) Foreign Application Priority Data
Oct. 29, 2015 (CN) 201510717967.6

(51) Int. Cl. H04L 29/08; H04W 56/00

(52) U.S. Cl. CPC H04L 67/1095; H04L 67/125; H04L 67/303; H04W 56/001

(57) ABSTRACT

A method for performing media synchronization includes extracting a first media file and a second media file from a mixed media file to be played. The first media file is to be played at a wireless output end and the second media file is to be played at a local output end. The method further includes dynamically monitoring a wireless transmission delay of the first media file and adjusting a play time of the second media file at the local output end based on the wireless transmission delay.

### CROSS-REFERENCE TO RELATED APPLICATIONS

This application is based upon and claims priority to Chinese Patent Application No. 201510717967.6, filed on Oct. 29, 2015, the entire contents of which are incorporated herein by reference.

### TECHNICAL FIELD

The present disclosure is related to communications, and more particularly, to a method, an apparatus and storage medium for performing media synchronization.

### BACKGROUND

A split-type television generally refers to a television having separate display part, signal processing part, and sound system, which is different from a conventional television having the above three parts integrated into one system as a whole. For example, a split-type television can include a television display terminal, a television console, and a television speaker.

### SUMMARY

In accordance with the present disclosure, there is provided a method for performing media synchronization including extracting a first media file and a second media file from a mixed media file to be played. The first media file is to be played at a wireless output end and the second media file is to be played at a local output end. The method further includes dynamically monitoring a wireless transmission delay of the first media file and adjusting a play time of the second media file at the local output end based on the wireless transmission delay.

Also in accordance with the present disclosure, there is provided an apparatus for use in media synchronization including a processor and a memory storing instructions that, when executed by the processor, cause the processor to extract a first media file and a second media file from a mixed media file to be played. The first media file is to be played at a wireless output end and the second media file is to be played at a local output end. The instructions further cause the processor to dynamically monitor a wireless transmission delay of the first media file and adjust a play time of the second media file at the local output end based on the wireless transmission delay.

Also in accordance with the present disclosure, there is provided a non-transitory computer-readable storage medium having stored therein instructions that, when executed by one or more processors of an apparatus, cause the apparatus to extract a first media file and a second media file from a mixed media file to be played. The first media file is to be played at a wireless output end and the second media file is to be played at a local output end. The instructions further cause the apparatus to dynamically monitor a wireless transmission delay of the first media file and adjust a play time of the second media file at the local output end based on the wireless transmission delay.

It shall be appreciated that the above general description and the detailed description hereinafter are only illustrative and interpretative, but not for limiting the present disclosure.

### BRIEF DESCRIPTION OF THE DRAWINGS

The accompanying drawings herein, which are incorporated into and constitute a part of the specification, illustrate embodiments consistent with the present disclosure, and together with the specification, serve to explain the principles of the present disclosure.

FIG. 1 is a schematic flowchart illustrating a method for performing media synchronization according to an exemplary embodiment of the present disclosure.

FIG. 2 is a schematic flowchart illustrating a method for performing media synchronization according to another exemplary embodiment of the present disclosure.

FIG. 3 is a schematic block diagram illustrating an apparatus for performing media synchronization according to an exemplary embodiment of the present disclosure.

FIG. 4 is a schematic block diagram illustrating an example of a monitoring module of the apparatus shown in FIG. 3.

FIG. 5 is a schematic block diagram illustrating an example of a selecting submodule of the monitoring module shown in FIG. 4.

FIG. 6 is a schematic block diagram illustrating an example of an adjusting module of the apparatus shown in FIG. 3.

FIG. 7 is a schematic block diagram illustrating another example of the monitoring module.

FIG. 8 is a schematic structural diagram illustrating an apparatus for media synchronization according to another exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terminology used in the present disclosure is for the purpose of describing particular embodiments only and is not intended to limit the present disclosure. As used in the present disclosure and the appended claims, the singular forms of “a” and “an” are intended to include the plural forms as well, unless the context clearly indicates otherwise. It shall also be understood that the term “and/or” used herein is intended to signify and include any or all possible combinations of one or more of the associated listed items.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be referred to as second information; and similarly, second information may also be referred to as first information. As used herein, the term “if” may be understood to mean “when” or “upon” or “in response to determining,” depending on the context.

When a split-type television plays a mixed media file, the split-type television extracts separate media files from the mixed media file, and plays the extracted media files at a wireless output end and a local output end, respectively, thereby achieving a good play effect.

However, the media file played at the wireless output end is generally transmitted based on wireless communication, which is subject to environmental interference, during playing of the media file by the split-type television. Therefore, the media file played at the wireless output end and the media file played at the local output end may be not synchronously played due to a delay generated during sending the media file to the wireless output end.

For example, the split-type television includes a woofer, e.g., a wireless woofer, connected to a console of the split-type television via a wireless connection. The woofer is the wireless output end of the split-type television. The console includes a loudspeaker as the local output end. When playing a mixed audio file, the split-type television extracts bass audio data and ordinary audio data from the mixed audio file by using a built-in audio codec module (Audio Codec).

Upon extracting the bass audio data and the ordinary audio data from the mixed audio file, the split-type television transmits the extracted ordinary audio data to the local loudspeaker. The loudspeaker plays the ordinary audio data. The split-type television also transmits the extracted bass audio data to the woofer via a built-in wireless module, for example, a WiFi module. The woofer plays the bass audio data.

However, since a wireless communication is subject to environmental interference, during transmission of data from the console to the woofer in a wireless manner, a transmission delay may occur. The transmission delay may dynamically change when the environmental interference changes. Therefore, the bass audio data played by the woofer may be not synchronized with the ordinary audio data played by the local loudspeaker, which results in poor user experience.

According to the present disclosure, a media synchronization method is proposed. According to this method, a first media file to be played at a wireless output end and a second media file to be played at a local output end are extracted from a mixed media file to be played, a wireless transmission delay of the first media file is dynamically monitored, and a play time of the second media file at the local output end is adaptively adjusted based on the monitored wireless transmission delay of the first media file, such that the first media file and the second media file are synchronously played. In this way, the problem of non-synchronized playing of the media files at the wireless output end and at the local output end due to the wireless transmission delay generated at the wireless output end can be avoided and the user experience can be improved. Methods and apparatuses consistent with the present disclosure can be implemented, for example in a split-type terminal, i.e., a control part, of a split-type system having multiple parts. The local output end is an integral part of the split-type terminal or is coupled to the split-type terminal in a wired manner, e.g., by a cable. On the other hand, the wireless output end can be coupled to the split-type terminal in a wireless manner, e.g., through a Wi-Fi network or a Bluetooth network. The split-type terminal can be, for example, a television console of a split-type television, a split-type conference terminal, a split-type camera, a personal computer or a mobile terminal capable of being connected with a wireless output end (such as a wireless woofer) and a local output end (such as a loudspeaker or a display screen), or a console of any other split-type device capable of playing a mixed media file. The mixed media file can be an audio file including bass audio data and ordinary audio data, or a video file including audio data and video data.

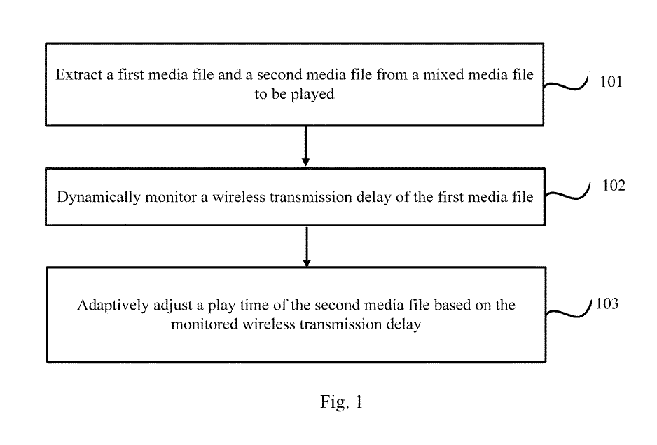

FIG. 1 illustrates a method for performing media synchronization according to an exemplary embodiment of the present disclosure. As shown in FIG. 1, at 101, a first media file and a second media file are extracted from a mixed media file to be played. The first media file is to be played at a wireless output end of the split-type terminal and the second media file is to be played at a local output end of the split-type terminal. At 102, a wireless transmission delay of the first media file is dynamically monitored. At 103, a play time of the second media file at the local output end is adaptively adjusted based on the monitored wireless transmission delay of the first media file, such that the first media file and the second media file are synchronously played.

In some embodiments, the first media file and the second media file can be extracted from the mixed media file by using a codec module built in the split-type terminal. For example, when the mixed media file is an audio file, the first media file can include bass audio data extracted from the audio file and the second media file can include ordinary audio data extracted from the audio file. When the mixed media file is a video file, the first media file can include audio data extracted from the video file and the second media file can include video data extracted from the video file.

In some embodiments, after the first media file and the second media file are extracted from the mixed media file, the split-type terminal can wirelessly transmit the first media file to the wireless output end via a wireless connection established with the wireless output end, and dynamically monitor the wireless transmission delay at the wireless output end.

For example, when the split-type terminal is the television console of a split-type television, the television console can dynamically monitor the wireless transmission delay during wireless output by selecting one or more key frames from data frames in the first media file and dynamically monitoring one or more transmitting time points of the selected one or more key frames and one or more reception time points of the one or more key frames reported by the wireless output end. The transmitting time point of a key frame refers to the time point at which the key frame is transmitted by the split-type terminal, and the reception time point of the key frame refers to the time point at which the key frame is received by the wireless output end.

In some embodiments, the television console can select a plurality of key frames based on a predetermined frame interval, such as a fixed frame interval. For example, frames 1, 11, 21 . . . in the first media file can be selected as the key frames based on a frame interval of 10 frames. Alternatively, the key frames can be selected based on a fixed time interval. For example, the key frames can be selected each two seconds according to a playing sequence of frames. In this manner, it is not necessary to monitor all the data frames in the first media file, and thus the calculation resources of the television console can be saved.

Upon selecting the one or more key frames, the television console can also add a predetermined mark into each of the selected one or more key frames. The predetermined mark can be a mark configured to trigger the wireless output end to report the reception time point of the key frame to the television console. Upon adding the predetermined mark, the television console can sequentially transmit the selected one or more key frames to the wireless output end by using a built-in wireless module according to a frame sequence, and record the transmitting time point of each of the one or more key frames. Upon receiving a data frame of the first media file transmitted by the television console, the wireless output end firstly checks whether the received data frame carries the predetermined mark. If the data frame carries the predetermined mark, the data frame is determined to be a key frame and the wireless output end can immediately report the reception time point of this key frame to the television console.

Upon receiving the reception time point of a key frame reported by the wireless output end, the television console calculates a difference between the reception time point and the transmitting time point of the key frame, to obtain a wireless transmission delay of the key frame. The television console can constantly transmit key frames to the wireless output end, and dynamically monitor the wireless transmission delay at the wireless output end by monitoring the reception time points of the key frames reported by the wireless output end.

In some embodiments, the television console can also periodically perform clock synchronization with the wireless output end, to ensure that the reception time point and transmitting time point of the key frame are recorded based on the same clock, such that the error in the calculated wireless transmission delay is reduced. For example, both the television console and the wireless output end can employ the clock of a CPU, that is, the clock of the CPU can be used as a reference for calibration.

In some embodiments, upon receiving the reception time point of a key frame reported by the wireless output end and calculating the wireless transmission delay according to the reception time point and a locally recorded transmitting time point, the television console can immediately and adaptively adjust the play time of the second media file at the local output end according to the wireless transmission delay, such that the first media file and the second media file are synchronously played.

The television console adaptively adjusts the play time of the second media file at the local output end by delaying sending the second media file to the local output end according to the calculated wireless transmission delay.

For example, the locally recorded transmitting time point of a key frame is T1 and the reception time point of the key frame reported by the wireless output end and received by the television console is T2, then the wireless transmission delay can be represented by a difference between T1 and T2, i.e., the wireless transmission delay Δt=T2−T1. When the television console calculates and obtains Δt, the television console can delay the time point of sending the second media file to the local output device by Δt, to ensure that the first media file and the second media file are synchronously played.

In some embodiments, monitoring the wireless transmission delay and delaying the play of the second media file at the local output end can be conducted dynamically. That is, after the television console adaptively adjusts the play time of the second media file at the local output end, if the television console receives the reception time point of another key frame reported by the wireless output end, the television console can calculate the wireless transmission delay again according to the recorded transmitting time point of the key frame and the received reception time point, and then further adaptively adjust the play time of the second media file at the local output end according to the newly calculated wireless transmission delay.

Thus, according to the present disclosure, the wireless output end can constantly report the reception time points of the key frames to the television console, and the television console can constantly calculate the wireless transmission delay and adaptively adjust the play time of the second media file at the local output end according to the wireless transmission delay. In this way, the effect caused by the wireless transmission delay can be reduced or eliminated, and the first media file and the second media file can be synchronously played.

Examples in which the mixed media file is an audio file and a video file will be described below respectively.

In some embodiments, the split-type television includes an audio codec module (Audio Codec), a video codec module (Video Codec), a CPU, a loudspeaker, a display, a wireless module, a wireless woofer, and a wireless speaker. The audio codec module is respectively coupled to the CPU and the loudspeaker in a wired manner, and the video codec module is respectively coupled to the CPU and the display in a wired manner. The CPU is coupled to the wireless module in a wired manner. The wireless module is respectively coupled to the wireless woofer and the wireless speaker in a wireless manner.

In some embodiments, the mixed media file is an audio file, the first media file includes bass audio data extracted from the audio file, and the second media file includes ordinary audio data extracted from the audio file. The woofer is the wireless output end. The loudspeaker is the local output end.

When the split-type television plays the audio file, the audio codec module continuously reads, according to a frame sequence, audio data frames from an audio track to be played, and then extracts bass audio data and ordinary audio data from the read audio data frames. The extracted bass audio data and ordinary audio data are respectively contained in bass audio data frames and ordinary audio data frames having the frame sequence of the original audio file. When the audio file includes a plurality of audio tracks to be played, the audio data frames can be simultaneously read from the plurality of audio tracks.

Upon completion of extracting the data, the audio codec module further selects key frames from the bass audio data frames based on a predetermined frame interval, and adds a predetermined mark into each of the selected key frames. The predetermined mark is configured to trigger the woofer to report the reception time point T2 of the corresponding key frame to the audio codec module. The predetermined mark can also be added by the CPU.

After the predetermined mark is added into the selected key frames, the audio codec module transmits the bass audio data frames to the woofer, and record the transmitting time point T1 of each of the key frames. Upon receiving a bass audio data frame, the woofer checks whether the bass audio data frame carries the predetermined mark. If the received bass audio data frame carries the predetermined mark, the bass audio data frame is determined to be a key frame. In this case, the woofer reports the reception time point T2 of the key frame to the audio codec module, and then continues receiving next bass audio data frame and repeats the above process.

Upon receiving the reception time point T2 of the key frame reported by the woofer, the audio codec module calculates a difference Δt between T2 and the recorded transmitting time point T1 of the key frame as a wireless transmission delay of the bass audio data. The audio codec module delays the time point of sending the ordinary audio data to the loudspeaker by Δt, such that the bass audio data and the ordinary audio data can be synchronously played. The audio codec module and the wireless woofer can use the clock of the CPU as a reference to periodically perform clock synchronization, to ensure the accuracy of the recorded transmitting time point or reception time point, and thus reduce the error in the calculated wireless transmission delay.

In some embodiments, the woofer can report the reception time point T2 of the key frame to the CPU. The CPU calculates the wireless transmission delay Δt, and then controls the audio codec module to delay the time point of sending the ordinary audio data to the loudspeaker by Δt.

In some embodiments, the media file is a video file, the first media file includes audio data extracted from the video file, and the second media file includes video data extracted from the video file. The wireless speaker is the wireless output end and the display is the local output end.

When the split-type television plays the video file, the video codec module continuously reads, according to a frame sequence, data frames from the video file to be played, and then extract audio data and video data from the read data frames. The extracted audio data and video data are respectively contained in audio data frames and video data frames having the frame sequence of the original video file.

Upon completion of extracting the data, the video codec module further selects key frames from the audio data frames based on a predetermined frame interval, and adds a predetermined mark into each of the selected key frames. The predetermined mark is configured to trigger the wireless speaker to report the reception time point T2 of the corresponding key frame to the video codec module. The predetermined mark can also be added by the CPU.

After the predetermined mark is added into the selected key frames, the video codec module transmits the audio data frames to the wireless speaker, and records the transmitting time point T1 of each of the key frames. Upon receiving an audio data frame, the wireless speaker checks whether the audio data frame carries the predetermined mark. If the audio data frame carries the predetermined mark, the audio data frame is determined to be a key frame. In this case, the wireless speaker reports the reception time point T2 of the key frame to the video codec module, and then continues receiving next audio data frame and repeats the above process.

Upon receiving the reception time point T2 of the key frame reported by the wireless speaker, the video codec module calculates a difference Δt between T2 and the recorded transmitting time point T1 of the key frame as a wireless transmission delay of the audio data. The video codec module delays the time point of sending the video data to the display by Δt, such that the audio data and the video data are synchronously played.

The video codec module and the wireless speaker can use the clock of the CPU as a reference to periodically perform clock synchronization, to ensure the accuracy of the recorded transmitting time point or reception time point, and thus reduce the error of the calculated wireless transmission delay.

In some embodiments, the wireless speaker can report the reception time point T2 of the key frame to the CPU. The CPU calculates the wireless transmission delay Δt, and then controls the video codec module to delay the time point of sending the video data to the display by Δt.

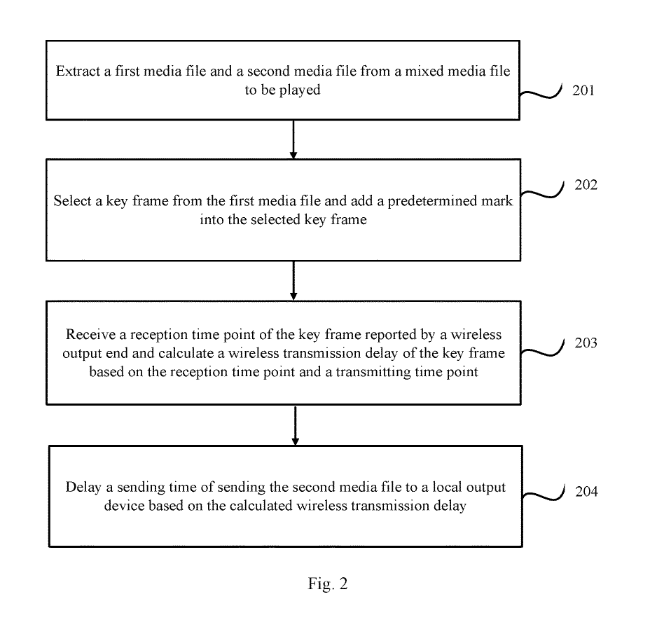

FIG. 2 illustrates a method for performing media synchronization according to another exemplary embodiment of the present disclosure. As shown in FIG. 2, at 201, a first media file and a second media file are extracted from a mixed media file to be played. The first media file is to be played at a wireless output end and the second media file is to be played at a local output end. At 202, a key frame is selected from the first media file and a predetermined mark is added into the selected key frame. The predetermined mark is configured to trigger the wireless output end to report a reception time point of the key frame. At 203, the reception time point of the key frame reported by the wireless output end is received and a wireless transmission delay of the key frame is calculated based on the reception time point and a transmitting time point of the key frame. At 204, based on the calculated wireless transmission delay of the first media file, a sending time for sending the second media file to the local output device is delayed, such that the first media file and the second media file are synchronously played.

The processes of extracting the first and second media files from the mixed media file, selecting key frames, adding predetermined mark, calculating the wireless transmission delay, and delaying sending the second media file to the local output device are similar to corresponding processes described above with reference to FIG. 1, and thus their detailed description is omitted here.

Exemplary apparatuses for performing media synchronization consistent with the present disclosure are described below. Operations of the exemplary apparatuses are similar to the exemplary methods described above, and thus their detailed description is omitted here.

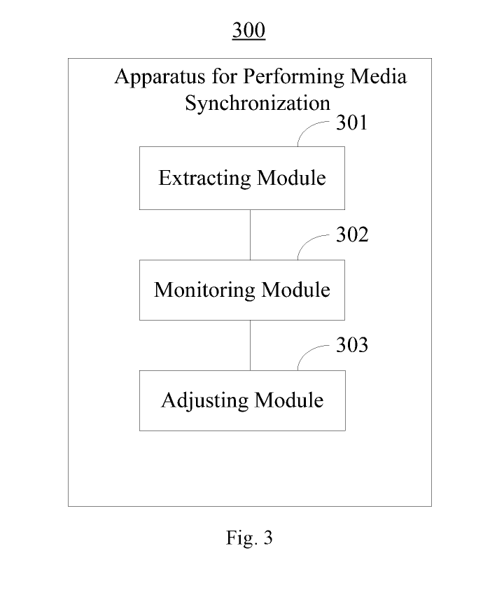

FIG. 3 is a schematic block diagram illustrating an apparatus 300 for performing media synchronization according to an exemplary embodiment of the present disclosure. As illustrated in FIG. 3, the apparatus 300 includes an extracting module 301, a monitoring module 302, and an adjusting module 303. The extracting module 301 is configured to extract a first media file and a second media file from a mixed media file to be played. The first media file is to be played at a wireless output end and the second media file is to be played at a local output end. The monitoring module 302 is configured to dynamically monitor a wireless transmission delay of the first media file. The adjusting module 303 is configured to adaptively adjust a play time of the second media file at the local output end based on the wireless transmission delay of the first media file monitored by the monitoring module 302, such that the first media file and the second media file are synchronously played.

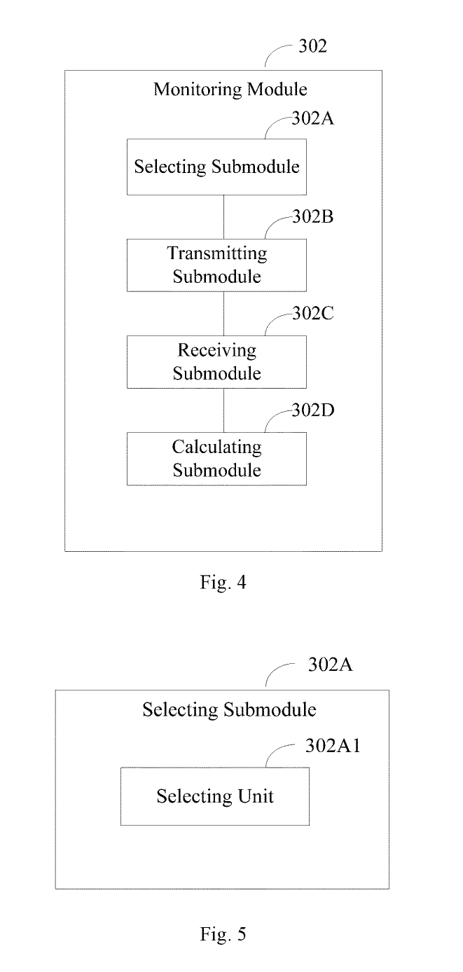

FIG. 4 is a block diagram illustrating an example of the monitoring module 302 in the apparatus 300 shown in FIG. 3. As shown in FIG. 4, the monitoring module 302 includes a selecting submodule 302A, a transmitting submodule 302B, a receiving submodule 302C, and a calculating submodule 302D. The selecting submodule 302A is configured to select a key frame from the first media file. The transmitting submodule 302B is configured to transmit the selected key frame to the wireless output end according to a frame sequence, and record a transmitting time point of the key frame. The receiving submodule 302C is configured to receive a reception time point of the key frame reported by the wireless output end. The calculating submodule 302D is configured to calculate the wireless transmission delay of the key frame based on the reception time point received by the receiving submodule 302C and the transmitting time point, to dynamically monitor the transmission delay of the first media file.

In some embodiments, a predetermined mark is added into the selected key frame. The predetermined mark is configured to trigger the wireless output end to report the reception time point of the key frame.

FIG. 5 is a block diagram illustrating an example of the selecting submodule 302A of the monitoring module 302 shown in FIG. 4. As shown in FIG. 5, the selecting submodule 302A includes a selecting unit 302A1 configured to select a plurality of key frames from the first media file based on a predetermined frame interval.

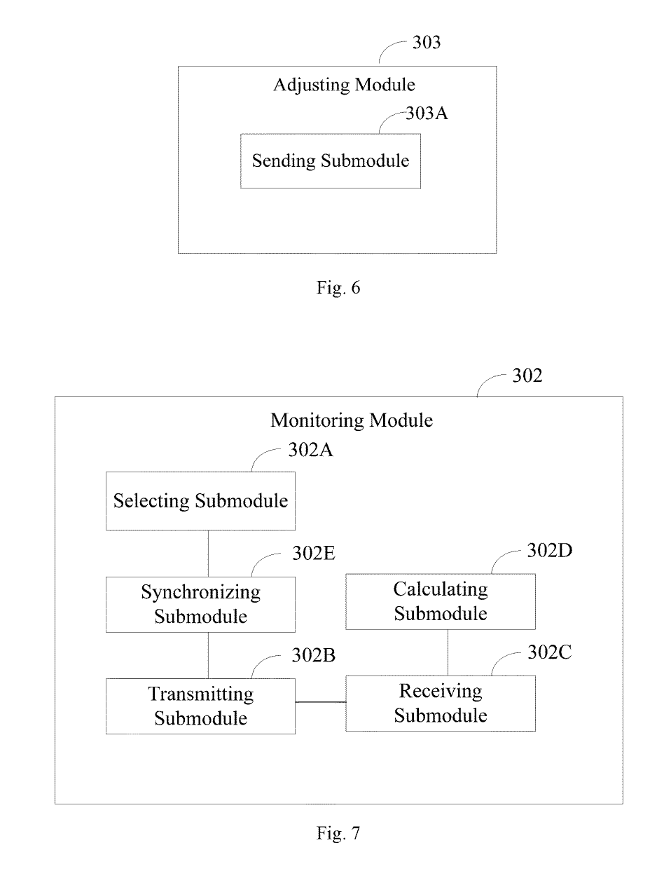

FIG. 6 is a block diagram illustrating an example of the adjusting module 303 of the apparatus 300 shown in FIG. 3. As shown in FIG. 6, the adjusting module 303 includes a sending submodule 303A configured to delay a sending time of sending the second media file to the local output device based on the wireless transmission delay of the first media file calculated by the calculating submodule 302D, to adaptively adjust the play time of the second media file at the local output end.

FIG. 7 is a block diagram showing another example of the monitoring module 302. The example shown in FIG. 7 is similar to the example shown in FIG. 4, except that in the example shown in FIG. 7, the monitoring module 302 further includes a synchronizing submodule 302E configured to periodically perform a clock synchronization with the wireless output end.

The above-described exemplary apparatuses are merely exemplary. The modules or units described as separate components may be or may not be physically independent of each other. The element illustrated as a module or unit may be or may not be a physical module or unit, that is, may be either located at a position or deployed on a plurality of network modules or units. Part of or all of the modules or units may be selected as required to implement the technical solutions disclosed in the embodiments of the present disclosure. By the disclosure, persons of ordinary skills in the art may understand and implement the embodiments.

Correspondingly, the present disclosure provides an apparatus for media synchronization. The apparatus includes a processor and a memory storing instructions that, when executed by the processor, cause the processor to perform a method for media synchronization consistent with the present disclosure, such as one of the above-described exemplary methods.

Correspondingly, the present disclosure further provides a split-type terminal including a memory storing at least one program. The at least one program is configured to be run by at least one processor to execute instructions, contained in the at least one program, for performing a method for media synchronization consistent with the present disclosure, such as one of the above-described exemplary methods.

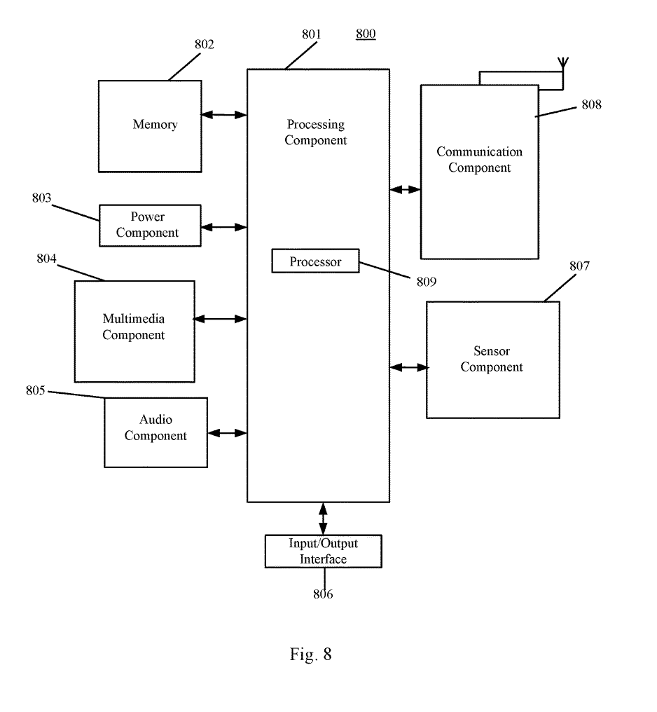

FIG. 8 is a schematic structural diagram illustrating an apparatus 800 for use in media synchronization according to another exemplary embodiment of the present disclosure. The apparatus 800 can be a mobile phone, a smart device, a computer, a digital broadcast terminal, a messaging device, a gaming console, a tablet, a medical device, exercise equipment, a personal digital assistant, or the like.

Referring to FIG. 8, the apparatus 800 includes one or more of the following components: a processing component 801, a memory 802, a power component 803, a multimedia component 804, an audio component 805, an input/output (I/O) interface 806, a sensor component 807, and a communication component 808.

The processing component 801 typically controls overall operations of the apparatus 800, such as the operations associated with display, telephone calls, data communications, camera operations, and recording operations. The processing component 801 may include one or more processors 809 to execute instructions to perform all or a part of a method for media synchronization consistent with the present disclosure, such as one of the above-described exemplary methods. In addition, the processing component 801 may include one or more modules that facilitate the interaction between the processing component 801 and other components. For example, the processing component 801 may include a multimedia module to facilitate the interaction between the multimedia component 804 and the processing component 801.

The memory 802 is configured to store various types of data to support the operations of the apparatus 800. Examples of such data include instructions for any application or method operated on the apparatus 800, contact data, phonebook data, messages, pictures, videos, and the like. The memory 802 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 803 provides power to various components of the apparatus 800. The power component 803 may include a power management system, one or more power supplies, and other components associated with the generation, management, and distribution of power in the apparatus 800.

The multimedia component 804 includes a screen providing an output interface between the apparatus 800 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 804 includes a front camera and/or a rear camera. The front camera and/or the rear camera may receive external multimedia data while the apparatus 800 is in an operation mode, such as a photographing mode or a video mode. Each of the front camera and the rear camera may be a fixed optical lens system or have focus and optical zoom capability.

The audio component 805 is configured to output and/or input audio signals. For example, the audio component 805 includes a microphone configured to receive an external audio signal when the apparatus 800 is in an operation mode, such as a call mode, a recording mode, or a voice recognition mode. The received audio signal may be further stored in the memory 802 or transmitted via the communication component 808. In some embodiments, the audio component 805 further includes a speaker to output audio signals.

The I/O interface 806 provides an interface between the processing component 801 and a peripheral interface module, such as a keyboard, a click wheel, a button, or the like. The buttons may include, but are not limited to, a home button, a volume button, a starting button, and a locking button.

The sensor component 807 includes one or more sensors to provide status assessments of various aspects of the apparatus 800. For example, the sensor component 807 may detect an open/closed status of the apparatus 800, relative positioning of components, e.g., the display and the keypad, of the apparatus 800; and the sensor component 807 may further detect a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 807 may include a proximity sensor configured to detect the presence of nearby objects without any physical contact. The sensor component 807 may also include a light sensor, such as a CMOS or CCD image sensor, for use in imaging applications. In some embodiments, the sensor component 807 may also include an accelerometer sensor, a gyroscope sensor, a magnetic sensor, a pressure sensor, or a temperature sensor.

The communication component 808 is configured to facilitate wired or wireless communications between the apparatus 800 and other devices. The apparatus 800 may access a wireless network based on a communication standard, such as WiFi, 3G; or 4G; or a combination thereof. In one exemplary embodiment, the communication component 808 receives a broadcast signal or broadcast associated information from an external broadcast management system via a broadcast channel. In one exemplary embodiment, the communication component 808 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, and another technology.

In exemplary embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method for media synchronization consistent with the present disclosure, such as one of the above-described exemplary methods.

In exemplary embodiments, there is also provided a non-transitory computer-readable storage medium including instructions, such as included in the memory 802, executable by the processor 809 in the apparatus 800, for performing a method for media synchronization consistent with the present disclosure, such as one of the above-described exemplary methods. For example, the non-transitory computer-readable storage medium may be a ROM, a random access memory (RAM), a compact disc read-only memory (CD-ROM), a magnetic tape, a floppy disc, an optical data storage device, or the like.

According to the present disclosure, a mixed media file is separated into a first media file and a second media file. A wireless output end receiving the first media file constantly reports wireless transmission delays of key frames in the first media file to a split-type terminal for the split-type terminal to constantly and adaptively adjust a play time of the second media file at a local output end according to the wireless transmission delays. As such, the effect caused by the wireless transmission delay occurred at the wireless output end on the second media file played at the local output end can be reduced or eliminated. Therefore, the first media file and the second media file can be synchronously played, and the user experience can be improved.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

1. A method for performing media synchronization, comprising:
extracting a first media file and a second media file from a mixed media file to be played, the first media file to be played at a wireless output end, and the second media file to be played at a local output end;
dynamically monitoring a wireless transmission delay of the first media file; and
adjusting a play time of the second media file at the local output end based on the wireless transmission delay.

2. The method according to claim 1, wherein dynamically monitoring the wireless transmission delay of the first media file comprises:
selecting a key frame from the first media file;
transmitting the selected key frame to the wireless output end and recording a transmitting time point of the key frame; and
receiving a reception time point of the key frame reported by the wireless output end; and
calculating a wireless transmission delay of the key frame based on the reception time point and the transmitting time point, as the transmission delay of the first media file.

3. The method according to claim 2, further comprising:
selecting a plurality of key frames from the first media file based on a predetermined frame interval.

4. The method according to claim 2, further comprising:
adding a predetermined mark into the key frame, the predetermined mark being configured to trigger the wireless output end to report the reception time point of the key frame.

5. The method according to claim 2, wherein adjusting the play time of the second media file comprises:
delaying a sending time of sending the second media file to the local output end based on the calculated wireless transmission delay.

6. The method according to claim 2, further comprising:
periodically performing clock synchronization with the wireless output end.

7. An apparatus for use in media synchronization, comprising:
a processor; and
a memory storing instructions that, when executed by the processor, cause the processor to:
extract a first media file and a second media file from a mixed media file to be played, the first media file to be played at a wireless output end, and the second media file to be played at a local output end;
dynamically monitor a wireless transmission delay of the first media file; and
adjust a play time of the second media file at the local output end based on the wireless transmission delay.

8. The apparatus according to claim 7, wherein the instructions further cause the processor to:
select a key frame from the first media file;
transmit the selected key frame to the wireless output end and record a transmitting time point of the key frame; and
receive a reception time point of the key frame reported by the wireless output end; and
calculate a wireless transmission delay of the key frame based on the reception time point and the transmitting time point, as the transmission delay of the first media file.

9. The apparatus according to claim 8, wherein the instructions further cause the processor to:
select a plurality of key frames from the first media file based on a predetermined frame interval.

10. The apparatus according to claim 8, wherein the instructions further cause the processor to:
add a predetermined mark into the key frame, the predetermined mark being configured to trigger the wireless output end to report the reception time point of the key frame.

11. The apparatus according to claim 8, wherein the instructions further cause the processor to:
delay a sending time of sending the second media file to the local output end based on the calculated wireless transmission delay.

12. The apparatus according to claim 8, wherein the instructions further cause the processor to:
periodically perform clock synchronization with the wireless output end.

13. A non-transitory computer-readable storage medium having stored therein instructions that, when executed by one or more processors of an apparatus, cause the apparatus to:
extract a first media file and a second media file from a mixed media file to be played, the first media file to be played at a wireless output end, and the second media file to be played at a local output end;
dynamically monitor a wireless transmission delay of the first media file; and
adjust a play time of the second media file at the local output end based on the wireless transmission delay.
